(19) United States
(12) Patent Application Publication
(10) Pub. No.: US 2024/0377191 A1
(43) Pub. Date: Nov. 14, 2024

(54) Heating for Sensor Units in Vehicles

(71) Applicant: Bayerische Motoren Werke Aktiengesellschaft, Muenchen (DE)

(72) Inventor: Andreas LANG, Groebenzell (DE)

(21) Appl. No.: 18/691,127

(22) PCT Filed: Oct. 24, 2022
(86) PCT No.: PCT/EP2022/079601

§ 371 Date: Mar. 12, 2024

(30) Foreign Application Priority Data
Oct. 28, 2021 (DE) 10 2021 128 126.1

(51) Int. Cl. G01B 17/02; B60S 1/56; G01S 7/40; G01S 7/497

(52) U.S. Cl. CPC G01B 17/025; B60S 1/56; G01S 7/4047; G01S 7/497; G01S 2007/4977

(57) ABSTRACT

A sensor device for use in vehicles is provided, having at least one sensor unit, which is configured to cover a detection area outside the sensor device, and at least one cover, which is arranged in front of the sensor unit or is formed as part of the sensor unit, and at least one heating element, which is arranged and configured to heat at least subregions of the cover, and also a control or regulating unit, which is configured to control or regulate the heating element in order to heat the cover. The sensor device is characterized by at least one wall thickness sensor that is formed, and arranged at a predefined distance from and/or in direct contact with and/or inside the cover, in such a way that it is able to determine the wall thickness of the cover, wherein it transmits the determined wall thickness to the control or regulating unit, which actuates the heating element in order to heat the cover if a predefined wall thickness is exceeded.

### BACKGROUND AND SUMMARY

The invention relates to heating for sensor units in vehicles.

Vehicles today often have one or more radar sensors that are used to monitor the environment of the vehicle, and are used e.g. as a parking aid or to measure the distance from a vehicle travelling ahead. Such radar sensors are installed at different locations in or on the vehicle and generally comprise a cover to protect the radar sensor from outside influences. The cover may be transparent or nontransparent and may be in the form of part of the vehicle, e.g. as a bumper cover, or as part of a housing of the radar sensor, which is mounted on a region of the vehicle.

To achieve the best possible quality for detection by the radar sensor, it is necessary to ensure that the beam path (transmission and reception of the radar beams) of the radar sensor is affected as little as possible. That is to say that any layer that is on the radar sensor or even the cover of the radar sensor is disruptive. Such layers may be e.g. ice layers, water or snow.

Known options for solving this problem are to install heating elements on the cover of the radar sensor, which for example provide a temperature sensor in order to actuate the heating element, as shown in DE 10 2019 123 404 A1. Alternatively, e.g. DE 10 2020 000 291 A1 proposes that the heating element be activated only when, in addition to the drop below a temperature, the radar sensor detects that a beam-obstructing layer is attached to the vehicle in its beam path and/or a rain sensor detects precipitation.

However, it is nevertheless still possible for the heating to be switched on regardless of the icing state of the radar cover, depending on exterior temperature and speed. This can lead to overheating in the wire region/connector region, which may result in damage to the heating elements.

It is therefore an object of this invention to provide improved heating for sensor units in vehicles. This object is achieved according to the invention by the features of the independent patent claims. Advantageous embodiments are the subject matter of the dependent claims.

The proposal is a sensor device for use in vehicles, comprising at least one sensor unit, which is configured to cover a detection region outside the sensor device, and at least one cover, which is arranged in front of the sensor unit or is in the form of part of the sensor unit, and at least one heating element, which is arranged and configured to heat at least subregions of the cover, and an open-loop or closed-loop control unit, which is configured to control the heating element in order to heat the cover. The sensor device is characterized by at least one wall thickness sensor, which is in a form, and arranged at a predefined distance from and/or in direct contact with and/or inside the cover, such that it may ascertain the wall thickness of the cover, the wall thickness sensor transmitting the ascertained wall thickness to the open-loop or closed-loop control unit, which, if a predefined wall thickness is exceeded, actuates the heating element to heat the cover. As soon as the wall thickness corresponds to the predefined wall thickness again, the heating element is switched off.

By providing a wall thickness sensor in the region of the cover that measures changes in the wall thickness of the cover, it is possible to quickly infer icing causing the change in wall thickness or snow adhering to the cover and to heat the cover as appropriate for thawing. If the wall thickness does not change, it is also not necessary to heat the cover, even if there would e.g. normally be provision therefor on the basis of the present exterior temperature and/or present weather conditions. It is thus also possible to prevent heating wires and/or plug connections from overheating, or to reduce the likelihood of overheating.

In addition, there is provision for the predefined wall thickness to correspond to the thickness of the cover. As soon as even just a thin film forms on the cover, it may be that the quality of the measurement by the sensor unit is no longer optimum. There is therefore provision for heating in the event of just a small change in the wall thickness.

In addition, there is provision for, in addition to the wall thickness being ascertained, a temperature to be detected by means of a temperature sensor. The temperature sensor is either a temperature sensor already present in the vehicle for determining the exterior temperature or a temperature sensor arranged on the cover that is configured to measure the temperature of the cover. In one embodiment, additionally a wind speed, ascertained by a vehicle-internal sensor system, of an airflow and/or an activity of a windshield wiper is detected and/or information from the sensor unit regarding the signal quality is transmitted to the open-loop or closed-loop control unit as additional information. Additional information may therefore be provided that is used to determine whether heating of the cover is necessary.

In addition, there is provision for the wall thickness sensor to be an ultrasonic sensor.

In addition, there is provision for the sensor unit to be one or a combination of: radar, lidar, camera, ultrasonic sensor.

In addition, there is provision for the cover to consist of a transparent or nontransparent material that is in a form such that it is transmissive for the transmission and reception of beams from the sensor unit. It is thus possible to use any material that has been used for covers to date.

In addition, there is provision for the cover to be in the form of a fully integrated or partially integrated part of the vehicle or in the form of a separate cover mounted on the sensor device.

Furthermore, a vehicle having at least one described sensor device is proposed.

Further features and advantages of the invention will emerge from the description of exemplary embodiments of the invention that follows, on the basis of the figures of the drawing, which shows details according to the invention, and from the claims. The individual features may be implemented in a variant of the invention individually in their own right or in groups of two or more, in any desired combination.

Preferred embodiments of the invention are explained in more detail below with reference to the accompanying drawings.

### BRIEF DESCRIPTION OF THE DRAWINGS

FIG. 1 is a schematic view of a sensor device according to an embodiment of the present invention.

FIG. 2 schematically shows a vehicle having a sensor device according to an embodiment of the present invention.

FIG. 3 schematically shows a method sequence according to an embodiment of the present invention.

In the descriptions of the figures that follow, identical elements or functions are provided with the same reference signs.

### DETAILED DESCRIPTION OF THE DRAWINGS

The basic principle of the invention is to improve the quality of detection of the environment by a sensor unit 1 arranged in a sensor device 100, in particular in cold temperatures. This is because in cold temperatures the problem may arise that the field of view of the sensor unit 1 is impaired by the formation of an ice or snow layer. To prevent this, a change in the wall thickness of a cover 2 of the sensor device 100 is determined and, if the wall thickness changes, the cover 2 is heated.

The sensor device 100 is arranged on or in a vehicle 200, in particular a motor vehicle such as a motor car or motorcycle, and comprises multiple components, which are described below.

There is provision for a sensor unit 1, which is configured to detect a region 10 (also referred to as the detection region 10) outside the sensor device 100. Furthermore, there is provision for a cover 2, which is placed in front of the sensor unit 1 and through which the sensor unit 1 detects the surroundings of the vehicle 200 within the detection region 10. The cover 2 may be in the form of a separate component or part of the sensor unit 1 (partially integrated or fully integrated). There is provision on or in the cover 2 for at least one heating element 4, which is used to heat at least one subregion of the cover 2, comprising at least the region of the cover 2 that comprises the detection region 10.

Furthermore, there is provision for an open-loop or closed-loop control unit 6, which is connected for communication and signalling purposes to the sensor unit 1 and other components needed for determination and performing the heating. It may thus both receive information (signals) therefrom and output commands (control signals) thereto. The open-loop or closed-loop control unit 6 may be in the form of part of the sensor device 100, that is to say even inside a housing thereof, or outside it.

The aim is to melt an ice layer or snow layer formed on a cover 2 as soon as it forms, that is to say as soon as the wall thickness of the cover 2 changes, i.e. begins to change.

This is achieved by providing at least one wall thickness sensor 5. The wall thickness sensor is arranged in the sensor device 100 in such a way that it may determine, e.g. measure, the wall thickness of the cover 2 of the sensor device 100. There may be provision for a single wall thickness sensor 5 or multiple wall thickness sensors 5, arranged at different positions. The information ascertained by the wall thickness sensor(s) 5 is transmitted to the open-loop or closed-loop control unit 6 for further processing. If the open-loop or closed-loop control unit detects that a predefined wall thickness of the cover 2 (which advantageously corresponds to the actual wall thickness of the cover 2) has been or is exceeded, it actuates the heating element 4 to heat the cover 2.

The heating is advantageously performed at a very early stage, that is to say as soon as a change in the wall thickness of the cover 2 has been detected. This prevents the cover 2 from freezing or being covered to a greater extent as a result of waiting with the heating, and clearance by heating from being hampered as a result.

The open-loop or closed-loop control unit 6 is configured to control, that is to say switch on or switch off, the heating element 4. However, it may also regulate the heating power of the heating element 4 if the heating element is in an appropriate form, e.g. with multiple heating circuits. Generally, the heating element 4 is embodied as wires (resistance heating), which are routed on or inside the cover 2 and heat up by being supplied with current.

The sensor unit 1 may be a radar sensor, and so the cover 2 is a radar cover, or a radome. Other sensors for monitoring the environment, environment sensors for short, may also be used, however, e.g. lidar, ultrasound or cameras, so long as they may be heated in their detection region. Furthermore, the sensor unit 1 may consist of multiple sensors, even different sensors, that have the same cover 2.

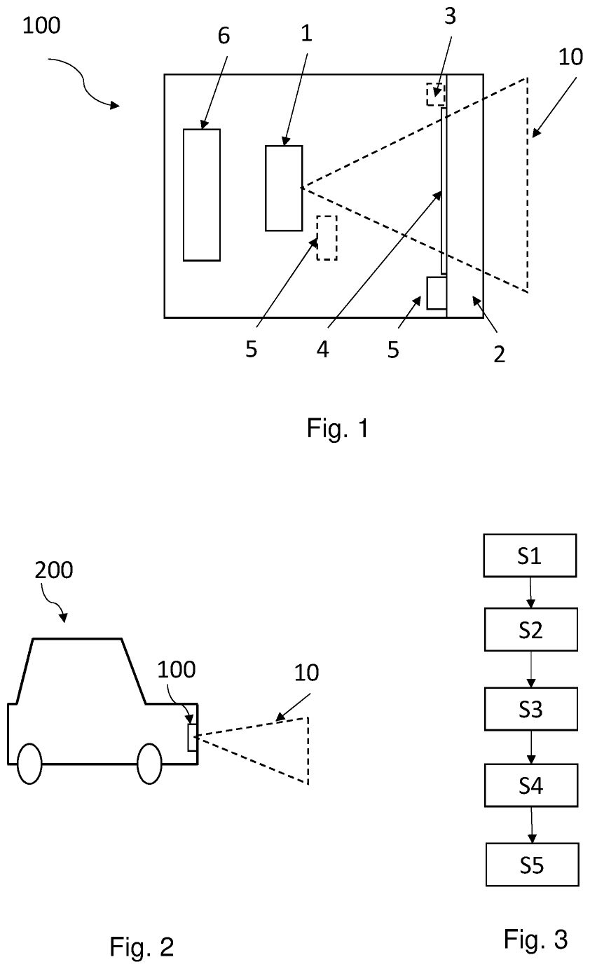

The wall thickness sensor 5 may be e.g. an ultrasonic sensor that is arranged in contact with the cover 2, as shown in FIG. 1. It is useful if the ultrasonic sensor is arranged outside the detection region 10 of the sensor unit 1 as far as possible, so as not to affect the transmitted beams. If it is in a form such that it does not impair the beams, it may also be arranged in the detection region 10, however. Other suitable sensors may also be used to determine the wall thickness.

The wall thickness sensor 5 is advantageously furthermore arranged behind the cover 2, that is to say in the region of the sensor device 100, in which there is also provision for the sensor unit 1. It is therefore not visible from the outside (outside the vehicle 200).

Depending on the embodiment, the wall thickness sensor 5 may be arranged in contact with the cover 2, but it may also be arranged at a distance therefrom (shown in dashed lines in FIG. 1) if measurement of the wall thickness is then still possible within predefined tolerance limits.

In addition to the information about a change of wall thickness, temperature information, e.g. about the present exterior temperature or the present temperature at the cover 2, may be used. For this purpose, a temperature of the cover 2 may be ascertained by means of a temperature sensor 3 (shown in dashed lines in FIG. 1). Such a temperature sensor 3 is advantageously arranged in contact with the cover 2, but advantageously outside a region that is exposed to strong sunlight. Alternatively, it may be arranged behind a protective layer or protective cover, etc., in order to achieve the most precise measurement results possible.

Separately or additionally, however, an exterior temperature ascertained in the vehicle 200 by a (vehicle-internal) exterior temperature sensor that is provided for that purpose and already present may also be used. In this case, the speed of travel, which is also generally known or can be ascertained from known data by means of a control unit, may additionally also be factored in, that is to say the airflow. Furthermore, information about an activity of a windshield wiper may additionally also be factored into the evaluation. With this information, e.g. the open-loop or closed-loop control unit 6 or a control unit connected thereto may be used to determine whether an ice layer or snow layer may form on the cover 2 and then to perform appropriate actions, e.g. putting the heating element 4 into a standby mode so that it is quickly available if needed, that is to say if a change in the wall thickness is ascertained. Furthermore, there may be provision for information from the sensor unit 1 about the signal quality to be transmitted to the open-loop or closed-loop control 6, e.g. by the sensor unit 1 itself. By way of example, this may be used to ascertain that the signal is noisy, which suggests impairment of the detection region 10 for example by icing.

The cover 2 may be transparent or nontransparent as well as fully integrated or partially integrated. It may be in the form of part of the vehicle 200 or in the form of a separate cover 2 or in the form of part of the sensor unit 1, e.g. in the form of a camera lens. It may be in the form of an optical element, e.g. in the form of a lens, beamforming optics, covering element, protective glass, etc. However, it may also consist of a plastic that is suitable for the application, that is to say e.g. transmissive to appropriate wavelengths. It may also be in the form of a radome.

It may be employed within the vehicle 200 in a wide variety of regions, e.g. front region (shown in FIG. 2) and/or rear region, and for a wide variety of purposes, e.g. parking, driver assistance functions in the field of automated through to autonomous driving, etc. Currently, frequent positions are in the region of the bumper, the radiator grille, at the rear, on wing mirrors, etc. The positions mentioned are not an exhaustive list, however. In particular in the field of automated driving and future autonomous or highly autonomous driving, different positions than the previous ones may also be useful.

In FIG. 1, the heating element 4 is arranged in the detection region 10 of the sensor unit 1. Its surface area is advantageously larger than the detection region 10. Furthermore, it is in a form such that it does not impair detection by the sensor unit 1. The heating element 4 may also be arranged outside the detection region 10 of the sensor unit 1, however.

FIG. 3 schematically shows a flowchart for a method for operating a sensor device 100 according to embodiments of the present invention. The method may be implemented by an algorithm as a software program that can be executed by a computer or processor.

In a first step S1, the wall thickness of the cover 2 is detected by the wall thickness sensor 5 and transmitted to the open-loop or closed-loop control unit 6. If the open-loop or closed-loop control unit determines a change in the wall thickness (step S2), it actuates the heating element 4 (step S3) to heat the cover 2. As soon as the wall thickness corresponds to the predefined wall thickness again (step S4), the heating element 4 is switched off (step S5). Additionally, information as described above may also be used for the open-loop or closed-loop control, that is to say e.g. temperature of the cover 2, exterior temperature, speed of travel, etc.

By providing a wall thickness sensor 5 and heating the cover 2 as soon as the wall thickness of the cover 2 changes, the cover 2 may be quickly cleared of ice and snow, which means that the detection region 10 of the sensor unit 1 is thus clear and the sensor unit therefore does not experience any impairment of the detection.

### LIST OF REFERENCE SIGNS

100 sensor device
1 sensor unit
2 cover
3 temperature sensor
4 heating element
5 wall thickness sensor
10 detection region
6 open-loop or closed-loop control unit
200 vehicle

1.-10. (canceled)

11. A sensor device for use in a vehicle, comprising:
at least one sensor unit, which is configured to cover a detection region outside the sensor device;
at least one cover, which is arranged in front of the sensor unit or which forms part of the sensor unit;
at least one heating element, which is arranged and configured to heat at least subregions of the cover;
an open-loop or closed-loop control unit, which is configured to control the heating element in order to heat the cover; and
at least one wall thickness sensor, which is in a form, and arranged at a predefined distance from and/or in direct contact with and/or inside the cover, so as to ascertain a wall thickness of the cover, the wall thickness sensor transmitting the ascertained wall thickness to the open-loop or closed-loop control unit, which, when a predefined wall thickness is exceeded, actuates the heating element to heat the cover.

12. The sensor device according to claim 11, wherein the predefined wall thickness corresponds to the thickness of the cover.

13. The sensor device according to claim 11, further comprising:
a temperature sensor, which, in addition to the wall thickness being ascertained, detects a temperature, the temperature sensor being:
(i) a temperature sensor already present in the vehicle for determining an exterior temperature, or
(ii) a temperature sensor arranged on the cover and configured to measure the temperature of the cover.

14. The sensor device according to claim 13, further comprising:
a vehicle-internal sensor system that ascertains a wind speed of an airflow and/or an activity of a windshield wiper, wherein
information from the sensor system regarding a signal quality is transmitted to the open-loop or closed-loop control unit as additional information.

15. The sensor device according to claim 11, wherein the wall thickness sensor is an ultrasonic sensor.

16. The sensor device according to claim 11, wherein the sensor unit is one or a combination of: radar, lidar, camera, or an ultrasonic sensor.

17. The sensor device according to claim 11, wherein
the cover is comprised of a transparent or nontransparent material in a form so as to be transmissive for transmission and reception of beams from the sensor unit.

18. The sensor device according to claim 11, wherein
the cover is in a form of a fully integrated or partially integrated part of the vehicle or in a form of a separate cover mounted on the sensor device.

19. A vehicle comprising at least one sensor device according to claim 11.

20. A method for operating a sensor device of a vehicle, comprising:
detecting a wall thickness of a cover of the sensor unit by a wall thickness sensor;
transmitting the detected wall thickness to an open-loop or closed-loop control unit, and,
when the open-loop or closed-loop control unit determines a change in the wall thickness, actuating a heating element to heat the cover.
